(19) United States
(12) Patent Application Publication
(10) Pub. No.: US 2007/0112460 A1
(43) Pub. Date: May 17, 2007

(54) Method and system for facilitating individualized packaging and follow-up capability on a mass scale

(76) Inventor: Daniel Kiselik, Short Hills, NJ (US)

Correspondence Address: RATNERPRESTIA, P O BOX 980, VALLEY FORGE, PA, 19482-0980, US

(21) Appl. No.: 11/590,365

(22) Filed: Oct. 31, 2006

Related U.S. Application Data
(60) Provisional application No. 60/732,251, filed on Nov. 1, 2005.

(51) Int. Cl. G06F 17/00; G06Q 30/00

(52) U.S. Cl. 700/233; 705/14

(57) ABSTRACT

According to one aspect, a method is provided for personalizing packaging for a product. The method includes offering personalized packaging for the product to a customer. Text, images, or text and images are received from the customer. The text, images, or text and images are integrated into personalized packaging, and the product with the personalized packaging is provided to the customer. Promotional information for the product or another product is also provided to the customer.

This application claims the benefit of U.S. Provisional Patent Application No. 60/732,251, filed on Nov. 1, 2005.

### FIELD OF THE INVENTION

This invention relates to a method and system for personalizing packaging and, more specifically, to a method and system for personalizing packaging that can facilitate follow-on personalized electronic and/or tangible offers or promotions.

### BACKGROUND OF THE INVENTION

Since the advent of interchangeable parts, assembly lines, and modern mass production, personalization has been costly and only feasible on larger, more expensive products. With the advent of computerization, mass personalization has been achieved but again, due to the costs involved, it has only been used in high-value or expensive items. Even with the recent use of digital printing, mass personalization is virtually absent from packaging.

As formulations and preparations specifically for an individual are becoming more common, especially in connection with cosmetics, foods, and pharmaceuticals, the need for branded, yet personalized, packaging and collaterals will arise. As printing costs are inversely related to the number of printed items produced, current methodologies and mechanisms are simply not equipped to satisfy this need in an economically practical manner. Furthermore, customized follow-ons, coupons, order forms, and instructions utilizing the information from the packaging are non-existent.

Various attempts have been made to personalize products. For example, U.S. Pat. No. 6,748,290 to Somaia, which is incorporated herein by reference, discloses a method of producing a textile product by receiving order information from a customer over a network, including an image to be reproduced on the textile product; processing the order information to create an order record readable by an automated weaving machine; and causing the weaving machine to weave the textile product according to the order record so as to have a representation of the image on a face of the textile product. U.S. Pat. No. 6,206,750 to Barad et al., which is also incorporated herein by reference, discloses a personalized toy and a method for marketing a toy through the use of computer screen images and a method of manufacturing a personalized toy. Computer screen images of different configurations of at least one of the components of a toy are displayed on a computer, and a customer viewing the displayed images is allowed to record a selected component configuration to be assembled as part of the personalized toy. A representational image of the toy incorporating the selected configuration may be displayed.

Nevertheless, it would be advantageous to provide an improved method and system for personalizing packaging.

### SUMMARY OF THE INVENTION

According to one aspect, a method is provided for personalizing packaging for a product. The method includes offering personalized packaging for the product to a customer. Text, images, or text and images are received from the customer. The text, images, or text and images are integrated into personalized packaging, and the product with the personalized packaging is provided to the customer. Using the personalization data, personalized product inserts and promotional information for the product or another product are also provided to the customer, which are also uniquely reflective of the customer. A corresponding system is also provided.

According to another aspect, a method for personalizing packaging for a product includes obtaining rights to commercial packaging formats, graphics and constructions for products and offering personalized variations of the standard commercial packaging for the products to a customer. A product selection, a packaging format corresponding to the selected product, and personal information corresponding to the selected packaging format are received from the customer. The personal information is seamlessly integrated into the packaging, and the selected product with the uniquely personalized packaging is provided to the customer.

According to yet another aspect, a method for personalizing packaging for a product includes combining custom information provided by a customer with standard elements to form a special customized packaging design. A limited run of customized packaging having the customized packaging design is prepared. Customized packaging, customized product inserts and customized follow-on marketing using specific components of the customized packaging design are provided to the customer.

According to yet another aspect, a method for personalizing packaging includes identifying personalized information that a customer wishes to be incorporated into personalized packaging and offering a selection of available graphic and structural packaging templates including those corresponding to actual brands. The personalized information is combined with a selected template to produce personalized packaging, and the personalized packaging is delivered to the customer. The personalized information is also incorporated into personalized packaging inserts and personalized follow-on promotional materials associated with both the brand and the customer.

According to another aspect, a system is provided for personalizing packaging for a product. The system includes a receiving unit configured to receive and aggregate appropriate customer information, including but not limited to data and images, as well as a brand selection from a customer. The system also includes a combination unit configured to intelligently integrate the customer information and the brand selection to produce an indistinguishable replica of commercial packaging featuring the customer and their specific information. A scalable production unit is provided as a component of the system and is configured to produce a personalized package which may be used either commercially, as a collectable or both.

According to yet another aspect, a system for personalizing packaging for a product includes an interface configured to receive custom information, including but not limited to data and images, from a customer; a computer configured to intelligently integrate the custom information with standard and commercial packaging elements to form a customized packaging design; a printer configured to prepare a limited run that is greater than or equal to one unit but less than a production run for conventional commercial uses, of customized packaging having the customized packaging design; and a communication device configured to deliver via electronic and/or conventional means, follow-on personalized marketing materials to the customer which in part are based upon designs derived from the components of the customized packaging design.

### BRIEF DESCRIPTION OF THE DRAWINGS

The invention is best understood from the following detailed description when read in connection with the accompanying drawings. Included in the drawings are the following figures:

FIG. 1A is a block diagram of a system for generating customized packaging according to an exemplary embodiment of the present invention.

FIG. 1B is a block diagram of a system for generating customized packaging according to another exemplary embodiment of the present invention.

FIG. 2 discloses a method and a system according to exemplary embodiments of the present invention.

FIG. 3 illustrates a flow chart for exemplary aspects of the method illustrated in FIG. 2.

FIG. 4 illustrates a system for generating customized packaging according to an exemplary embodiment of the present invention.

FIG. 5 illustrates a system for generating customized packaging according to another exemplary embodiment of the present invention.

### DETAILED DESCRIPTION OF THE INVENTION

This invention will now be described with reference to several embodiments selected for illustration in the drawings. It will be appreciated that the scope and spirit of the invention are not limited to the illustrated embodiments.

An exemplary embodiment of the present invention provides a system that both enables an existing design or brand identity to be mass personalized for packaging and provides the method or mechanism for aggregating the customer information (e.g., preferences, personal data, etc), images supplied by the customer, and/or information from the brand together into a personalized package or follow-up via electronic or conventional delivery. A method or system for mass personalization of tangible printed products (where an image is applied, for example), in addition to packaging, is also provided.

According to one exemplary aspect, the present invention provides a system and a method for mass customization of packaging. The system and method make it possible for companies to advance brand loyalty for products by making customized packaging available to a large number of customers. The result is packaging for a famous brand that is uniquely personalized to an individual customer.

The method for personalizing packaging for a product optionally includes (1) obtaining rights to packaging formats for products; (2) offering personalized packaging for the product to a customer; (3) receiving a selection from the customer including a product, a packaging format corresponding to the selected product, and custom information corresponding to the selected packaging format in the form of text, images, or text and images; (4) integrating the text, images, or text and images into personalized packaging by combining custom information provided by a customer with standard elements to form a customized packaging design; (5) preparing a limited run which is greater than or equal to one and less than a production run, of customized packaging having the customized packaging design; (6) providing the customized packaging to the customer, including the selected product with the personalized packaging and any collateral information which may also be personalized as required; and (7) providing customized follow-on marketing to the customer using components of the customized packaging design, thereby providing promotional information for the product or another product to the customer.

The method according to one embodiment of the present invention may be used by a brand manager to promote an existing product and includes the following exemplary steps:

(1) A brand manager for a well known product produced by a brand company, seeking to create a stronger bond between its customers and the product, offers personalized packaging facsimiles with personal information (e.g., the customer's text and/or images) printed directly on the package.

(2) The personalized packaging is offered to customers on production packaging of the product (including but not limited to boxes, cans, bottles, bags & wrappers), through circulars, via broadcast media, on the internet, etc.

(3) The customer provides text and/or images to an intermediary company that runs the order entry, production, fulfillment and shipment of the personalized packaging. The customer may provide the text and/or images by, for example:
a) sending the information via a disk;
b) sending the information by electronic mail (“email”);
c) uploading the information via a website or a website link; or
d) uploading the information using a file transfer protocol, such as File Transfer Protocol (“FTP”).

(4) The text and/or images are integrated into the personalized packaging (a custom facsimile package) by the intermediary company, produced and shipped to the customer.
(4a) The text and/or images are integrated into the personalized packaging (a custom facsimile package) on-line in realtime by the customer using web-based software hosted by the intermediary company, produced and shipped to the customer.
(4b) The text and/or images are integrated into the personalized packaging (a custom facsimile package) in realtime by the customer using locally installed client software supplied by the intermediary company, which is then uploaded to the intermediary company, produced and shipped to the customer.

(5) Supplemental information or materials are provided to the customer by the intermediary company, including for example an image of the personalized packaging, coupons featuring the customer's personal information, a customized survey about the brand, etc.

Although step (3) indicates that an intermediary company runs the order entry, production, fulfillment and shipment of the personalized packaging, it is contemplated that the provider company may perform these tasks as well.

The method according to another exemplary embodiment of the present invention may be used by a brand manager to promote a subsequent product and includes the following exemplary steps:

(1) When the brand manager introduces a new product, the intermediary company is used to create a new promotional piece using the personalized text and/or images specified by a customer and a new product package. The customer may have supplied the text and/or images when specifying personalized packaging facsimiles with personal information for an existing product.

(2) The intermediary company creates and ships new personalized packaging containing text and/or images on the new packaging to prior customers and notifies them of shipment.

(3) Again, supplemental information or materials are provided to the customer, including an image of the personalized package, coupons featuring the customer's text and/or images, a customized survey about the brand, etc.

For the method just described, it is contemplated that a provider company may perform some or all of the steps performed by the intermediary.

The method according to yet another embodiment of the present invention may be used by the intermediary to sell personalized packaging and includes the following exemplary steps:

(1) The intermediary company licenses or otherwise obtains rights to packaging for popular products and offers personalized packaging directly to customers.
(1a) The intermediary may make these choices of packaging options available to the consumer through a website, a plugin to a third party web based photofinisher's website and/or software, a dedicated localized kiosk situated in a public place or as an adjunct to a photofinisher's kiosk situated in a public place.

(2) A customer selects the product package they wish to personalize and optionally selects a format for the packaging, such as a holiday ornament format, a key ring format, a sport bottle format, etc.

(3) After choosing the product package and/or optional format, the customer then provides personal information in the form of text and/or images to be featured on the packaging.

(4) The customer pays the intermediary company.

(5) The personalized packaging is prepared and shipped.

For the method just described, it is contemplated that a provider company may perform some or all of the steps performed by the intermediary.

The method and system also make it possible to design, develop, preview and have manufactured customized, personal packaging from the combination of a user's content and content that resides within a centralized development environment. This process can be web-based where it would be based on the intermediary's hosted system or it could be client/server based where the software would reside on the customer's system and the intermediary's host system. Further the system could be a “plugin” to an existing photo-finisher (e.g., Kodak's ophoto™, HP's Snapfish™, Shutterfly™, etc) or community picture sharing site (e.g., flickr™, myspace.com™, Facebook™ etc). Further the point of acquisition could be terrestrially based via a kiosk, either stand alone or offered as an adjunct to available offering (e.g., an offering of Kodak, Walgreens Company, etc). Accordingly, a user can integrate specific content that may be composed of pictures and text into “retail” style packaging, e.g., cartons, bags, cans, and jars. A central location contains basic templates composed of graphical and physical characteristics for each class of package.

According to such an embodiment:

(1) A working interface is provided (e.g., offered to the user to upload, to apply the desired content into a template and orient, position and alter the content as required or otherwise presented to the user). This interface may be, for example, an email link to a web page or may be a web page directly. The interface may be a local or remote program facilitating template selection (e.g., templates selected from a bank of existing templates or modifications of existing retail packaging), with selections being made and optionally displayed. The interface may also be a local or remote program facilitating content transfer (e.g., content selected from digital pictures, text files, and/or graphic elements), with an interface to capture and/or acquire and/or retrieve customer order information (including for example quantity, shipping and payment information) optionally offered to the user.

(2) The user elements and the standard elements are combined via manual and/or fully automatic means to create a digital representation of the desired product.

(3) The product is produced physically using digital or conventional production means to yield a limited run of customized packaging.

(4) The product is delivered based upon the information in step (1).

(5) User-supplied text and/or visual content may be captured and reused in part or whole for marketing and follow-on marketing, e.g., custom emails, coupons, offers and other products.

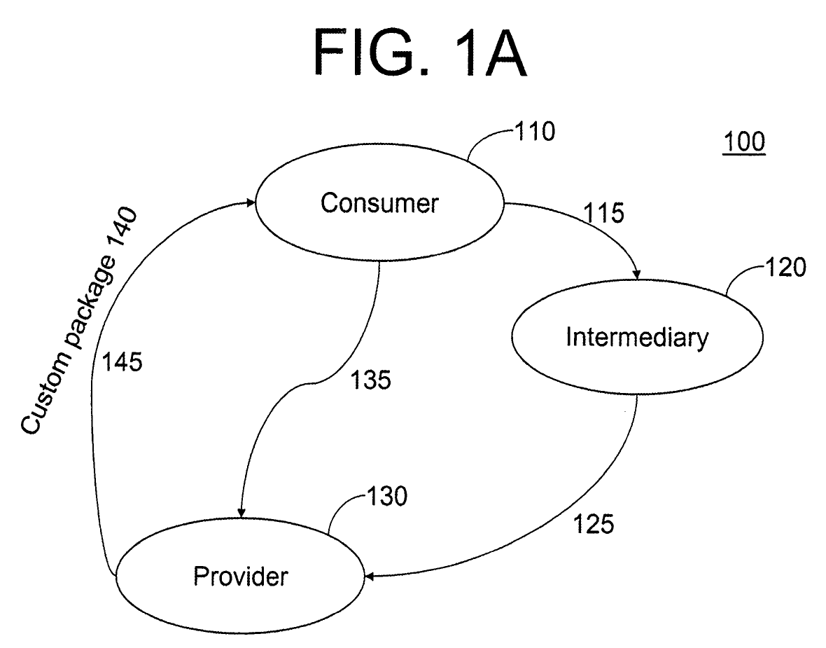

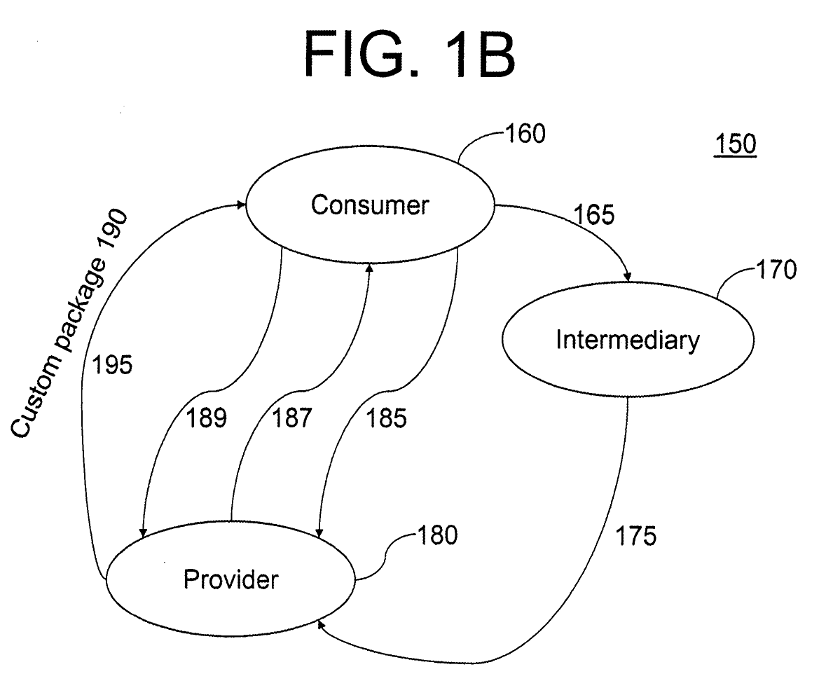

Exemplary methods and systems according to aspects of this invention will now be described with reference to the figures. FIG. 1A illustrates a method employing an exemplary embodiment of the present invention for personalizing and promoting packaging. In the personalization and promotional packaging system 100 disclosed in FIG. 1A, the customer or consumer 110 makes electronic contact 115 with an intermediary 120 or electronic contact 135 directly with a provider 130. With electronic contacts 115 and 135, consumer 110 specifies information, such as pictures, text, components, and templates, for inclusion in the end product, a custom package 140.

If the consumer makes direct electronic contact 135 with provider 130, then provider 130 assembles consumer 110's desired pictures, text, components, and templates, generates custom package 140 or proposal and delivers it to consumer 110 via delivery channel 145. Custom package 140 may consist only of packaging or may contain physical goods.

If the consumer makes electronic contact 115 with intermediary 120, such as when intermediary 120 has a license arrangement or other arrangement with provider 130 which allows provider 130 to use intermediary 120's brand identification, then intermediary 120 may pass consumer's desired pictures, text, components, and templates via communication channel 125 to provider 130. Provider 130 assembles the consumer 110's desired pictures, text, components, and templates; generates custom package 140 or proposal; and delivers it to consumer 110. For the method illustrated in FIG. 1A, it is contemplated that provider 130 may perform some or all of the steps performed by intermediary 120.

FIG. 1B discloses a method employing an exemplary embodiment of the present invention for personalizing and promoting packaging. In the personalization and promotion of packaging system 150 disclosed in FIG. 1B, customer or consumer 160 makes contact 165, such as by mail, electronically or otherwise with intermediary 170 or contact 185, such as by mail, electronically, directly with provider 180 or otherwise. With physical contacts 165 and 185, consumer 160 provides information, such as coupons, proof of purchase seals, and payment information. If intermediary 170 has an arrangement with provider 180 for provider 180 to produce the customized packaging or promotion, intermediary 170 forwards the received information to provider 180 by channel 175. Provider 180 receives and records the information sent by consumer 160.

After receiving the information which identifies the consumer's preferences either by physical contact 185 or channel 175, provider 180 verifies that consumer 160 has sent the proper information, and makes electronic contact 187 via an integrated conduit with consumer 160. Provider 180 then requests consumer 160 to further provide digital information necessary to customize custom package 190. Electronic contact 187 may be made via an email message that requests consumer 160 to reply by an email message that includes an image, text, template preferences, and other preferred components, which consumer 160 desires to have incorporated into custom package 190. Electronic contact 187 may be made via an email message that requests consumer 160 to click on an Internet link to go to an Internet web page to receive from consumer 160 images, text, template preferences, and other preferred components, which consumer 160 desires to have incorporated into custom package 190.

Customer 160 provides the requested images, text, template preferences, and other preferred components via electronic contact 189. Electronic contact 189 may be in the form of a return email, which may include attached electronic files, or may be in the form of information specified on an Internet website hosting an html or xml interface. Additionally, electronic contact 189 may be in the form of electronic communications made by a local or remote program utilizing a file transfer protocol type transfer captive exchange mechanism, such as FTP, for example.

After receiving consumer 160's preferred images, text, template, and other preferred components, provider 180 assembles consumer 160's desired pictures, text, components, and templates, generates custom package 190 or proposal, and delivers it to consumer 160 via delivery channel 195. Custom package 190 may consist only of packaging or may contain physical goods. For the method illustrated in FIG. 1B, it is contemplated that provider 180 may perform some or all of the steps performed by intermediary 170.

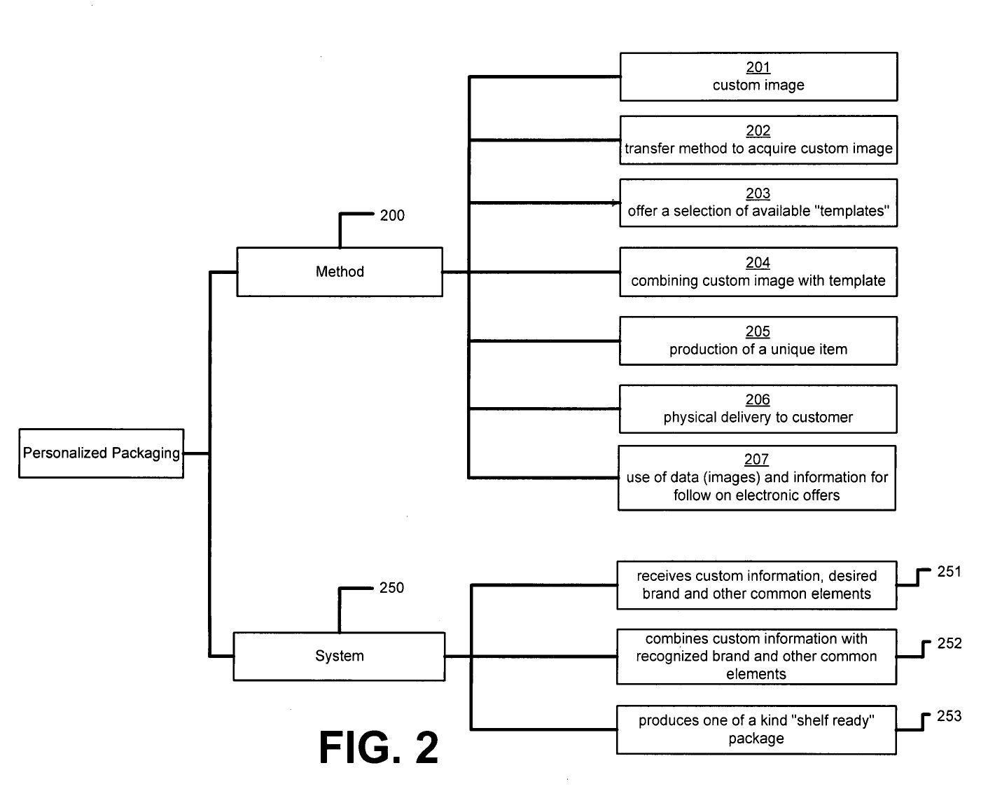

FIG. 2 discloses a method 200 and a system 250 for personalizing packaging according another exemplary embodiment of the present invention. The method 200 followed for personalizing packaging or promotions includes the steps of:

(1) Choosing 201 the image and information. The customer may choose an image and other information, such as text, that he or she wishes to be incorporated into packaging.

(2) Transferring 202 the custom image and the other information to a provider who will provide the customized packaging or promotion. The customer may send the image or other information to the provider as an attachment to an email message, or the customer may visit a website and upload the image via the website. The customer may also use some other software package which uses a file transfer protocol for transmitting the image to the provider.

(3) Offering 203 a selection of available templates. The provider offers a set of templates from which the user may select a desired template for the packaging. A template may specify a brand and the look and placement of brand identifiers. For example, one template may identify the product brand in one font at the top of the packaging template. Another template may identify the corporate brand in another font at the left side of the packaging template. The user may select the template via email message, by visiting a website, or by using some other software package to specify the template.

(4) Combining 204 the custom image with the template. The provider combines the custom image and other information supplied by the customer with the template chosen by the customer.

(5) Production 205 of a unique item. The provider uses the combination of the custom image, the other information, and the template to produce a unique item, such as customized packaging or promotional materials.

(6) Physical delivery 206 to the customer. The provider delivers to the customer the customized packaging or the customized promotional materials.

(7) Use 207 of data (e.g., images) and information for follow-on electronic or other physical (e.g., mail) offers. The provider may use the custom image, other information, and text to generate an electronic or conventional offer that incorporates the image into the template. At a later time, the provider may use the custom image and other information for incorporation into another electronic or conventional offer based upon another template.

FIG. 2 also discloses a system 250 for personalizing packaging according an exemplary embodiment of the present invention. The system for personalizing packaging or promotions includes the elements of:

(1) a receiving unit 251 for receiving the custom information (e.g., picture) and the customer's desired brand from the customer;

(2) a combination unit 252 which combines the customer information and the desired brand; and

(3) a scalable production unit 253 for producing a one-of-a-kind package that is “shelf ready.”

An illustrative receiving unit 251 is a computer processing unit connected to an electronic transfer system, or a web service configured to receive and store the customer's information. Similarly, the combination unit 252 may be a computer processing unit that runs a back end program which combines the customer information with common elements. An illustrative back end program is Adobe Photoshop™, available from Adobe Systems Incorporated of San Jose, Calif. The receiving unit 251 and the combination unit 252 may be a single computer processing unit or may be separate units. An example of a scalable production unit 253 is a digital printing press that can be configured to produce large or small runs of customized products, even a single run or a single item of the customized product.

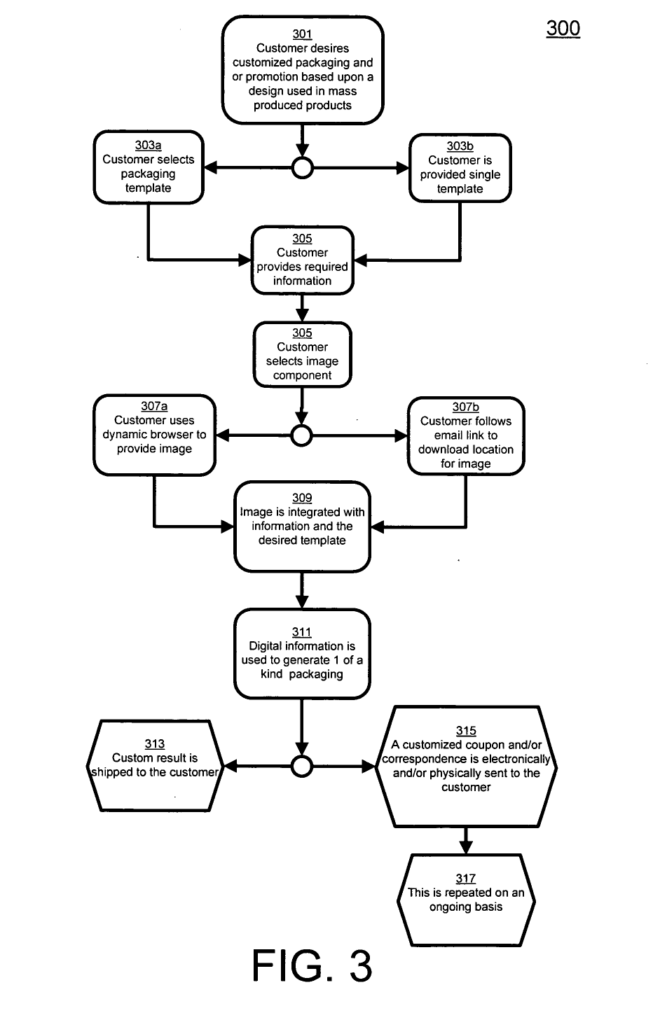

FIG. 3 illustrates a flow chart 300 for exemplary aspects of the method 200 of FIG. 2. The method 300 for producing customized packaging and promotions begins with a customer desiring 301 customized packaging and/or promotional materials based upon a design used in mass-produced products. The customer may either select 303a a packaging template from a group of predefined templates or may be provided 303b a single template.

After the template is determined, the user provides 305 information required to complete the customization. Such information may be, for example, a custom image, graphics, or text to be incorporated into the customized packaging or promotion. The customer may provide this information and image component using 307a a dynamic browser or by following 307b an email link to a download location, or by other means, for example, providing a disc or the like with the information thereon.

In the next step, the image is integrated 309 with the information specified by the customer as well as with the desired template relating to the desired brand or product. The combined image and information is then used 311 to generate the one-of-a-kind packaging by printing the customized image and information combination on the packaging. The custom result is then shipped 313 to the customer.

A customized coupon and/or correspondence based upon the custom image combined with the desired template may be electronically and/or physically sent 315 to the customer. Correspondence may be sent to the customer on an on-going basis 317 and each piece of correspondence may combine the custom image with the customer's original template, which was either chosen by the customer or supplied to the customer, or with another template corresponding to another brand or product that is being promoted.

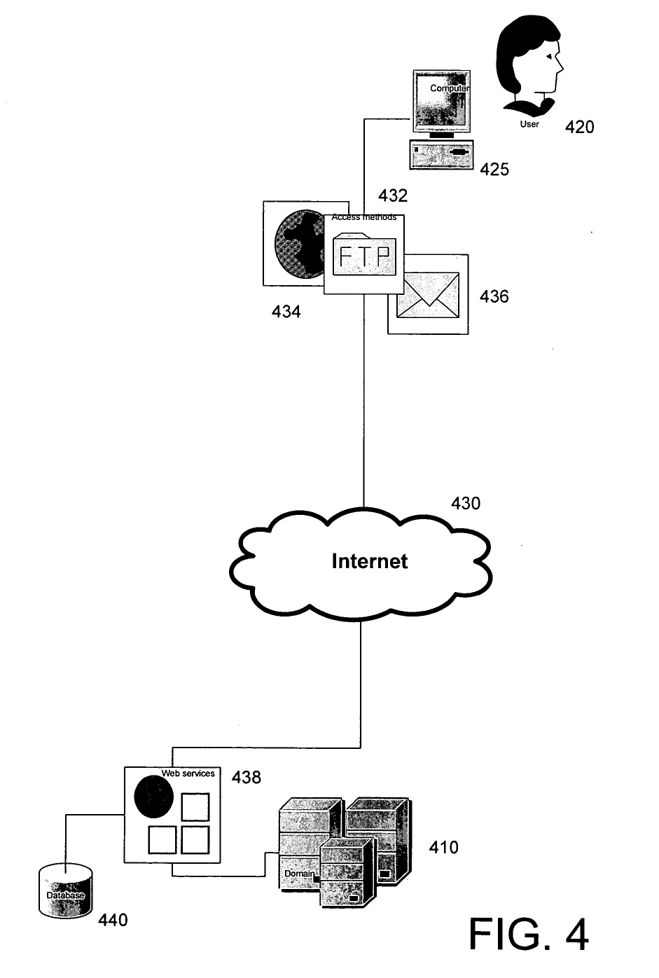

FIG. 4 illustrates a system for generating customized packaging according to an exemplary embodiment of the present invention. User 420 uses computer 425 to communicate his custom image and text via Internet 430 to web services 438. User 420 may communicate the custom image and text using a webpage 434, email messaging 436, or file transfer protocol 432, for example. Web services 438, which are hosted by domain 410, receive the image and information specified by user 420 and store them in database 440.

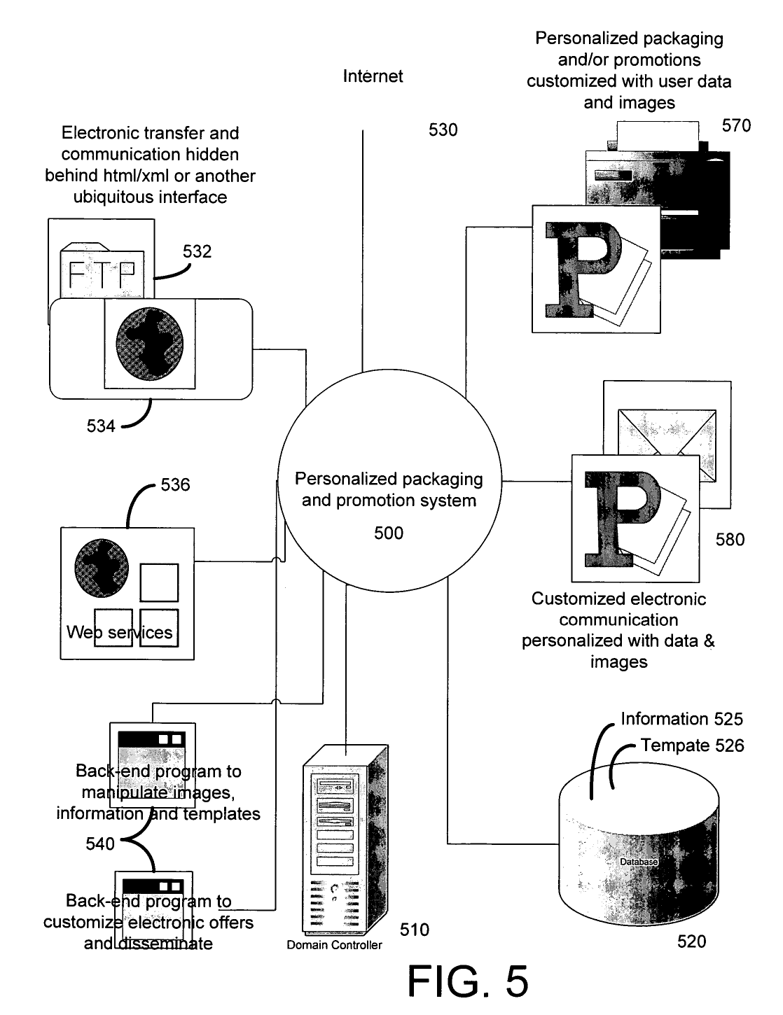

FIG. 5 illustrates a system employing an exemplary embodiment of the present invention for personalizing and promoting packaging. Personalized packaging and promotion system 500 includes a computer 510 associated with a database 520 which stores templates of branded packaging designs. Database 520 is capable of storing and organizing information 525 provided by a user of system 500. Information 525 may include data such as personal preferences, facts, images, text or other unique customer data. Information 525 is received via Internet 530. In an exemplary embodiment, a user supplies information 525 using an FTP connection 532. In another exemplary embodiment of the present invention, the user supplies information 525 through an interface 534 which may make use of an html or xml interface. In yet another exemplary embodiment of the present invention, the user supplies information 525 by email or by a webpage. Web service 536 receives information 525 supplied by the user over Internet 530. Database 520 stores information 525.

A back end program 540, which may be executed by domain controller 510, may retrieve, store, and manipulate information 525 and templates 526 stored in database 520 to generate the personalized packaging or personalized promotions. Back end program 540 may also use information 525 and templates 526 stored in database 520 to customize and disseminate electronic offers. Computer 510 interfaces and connects to a network, such as Internet 530, to communicate with a digital printing press and converting unit 570 and customized electronic communication unit 580. Unit 570 generates personalized packaging or promotions using one or more of the templates 526 chosen by the user and personalized with data, text, and images from information 525.

In an exemplary embodiment, unit 570 generates the personalized packaging or promotions by using a digital printer to print the desired design on the packaging or promotion. Unit 580 generates customized electronic communications, such as email messages, using template 526 chosen by the user and personalized with data, text, and images from information 525. In an exemplary embodiment, templates 526 relate to a product chosen by the user and the customized electronic communication generated by unit 580 includes templates 526 relating to the product chosen by the user. In another exemplary embodiment, the customized electronic communication generated by unit 580 includes a template not related to a product chosen by the user but instead related to a product the system 500 determines the user might be interested in.

### EXAMPLES

### Example 1

### Dog Biscuits

A brand manager for a company that produces a well-known brand of dog biscuits may seek to create a stronger bond between its customers and the brand. The company may offer packaging facsimiles with the customer's dog printed directly on the package along with customized text.

The offer is optionally featured on the production boxes of dog biscuits, through circulars, via broadcast media, or on the Internet. The offer optionally requires that the customer buy a number of boxes of dog biscuits, clip the proof of purchase seals, and return them with a filled-out offer form and a payment. An intermediary company can be used to run the order entry, production, fulfillment, and shipping. When the intermediary receives the completed offer, satisfaction is validated, information is entered into a database, and an email with a specific link leading to a unique and secure upload site is sent to the customer. The customer receives the email and follows the link to the target area, where the specific picture of the dog is uploaded.

Once the picture is uploaded, it is digitally processed, cropped and sized to fit onto the package. The photo is then digitally integrated into the package and unique text about the dog and its owners are added. The completed art is saved as a unique file and sent to production. The production phase yields a promotional piece, i.e., a custom facsimile package with the photo of the customer's dog. The completed piece is packaged for shipping along with collateral enclosures (samples, offers, etc.). The final unit is shipped out to the customer.

Once shipped, an email featuring a digital picture of the promotion is optionally sent to the customer informing them that the item is on the way. Two months later (or at another set interval), a second email is optionally sent to the customer that includes a printable coupon featuring their pet. A survey about the brand may be sent in a customizable and unique emailing. Additional customized emails with offers are optionally sent based upon the information supplied in the initial form. Once the entire promotional event has been completed, the data is stored.

A year later, for example, a new dog treat may be developed and the brand company may wish to automatically send it to the customers who responded to the initial offer. The brand company contracts the intermediary to use the prior data and create a similar promotional concept using the new package. The brand company pays the intermediary directly which then processes all the photos to the required specifications of the new package. The packages are created, prepped for shipping, packed up with collaterals or actual product, and sent off to the customers. An email is optionally automatically sent informing the customer or customers of the product coming to them.

After the items have been received, the intermediary optionally has a questionnaire email automatically sent to each customer. Those that respond are automatically sent a customized mailing featuring a printable coupon with their pet. The survey results are sent to the brand company.

Several years later, for example, the intermediary may decide to license the rights to several popular packages and may offer directly to the customer an opportunity to feature themselves, family, and friends on these packages. The customers can go to a website and select the consumer package that they want to use. They can then choose the form into which to integrate this, i.e., a facsimile holiday ornament, a mini-package, a key ring, a sport bottle, etc. The customer then can upload the art directly as they fill in the required information and authorize a charge to their account or alternative payment.

The prepping process for the art, the production, and the shipping are as above. An email is sent to the customer featuring the personalized package notifying that the order has shipped and including a coupon for the product. Additionally, information may be sent to the brand manger who may authorize follow-up offers via email, loyalty programs by creating and supplying new promotional items, or invitations to special events.

If the personalized dog biscuit packaging is provided over the Internet at the website of the dog biscuit seller or an intermediary, the customer is optionally asked to follow the following steps:

Step 1: Upload Pet Photo

In this Step 1, the customer is asked to upload a photo of the pet that they would like to appear on the package, and enter their pet's name. A high resolution image taken from a digital camera or a properly scanned photograph is optionally requested, and lower resolution pictures taken from camera phones, for example, can also be used.

Step 2: Enter Shipping Information

In this Step 2, the customer is asked to enter their name, address, and phone contact number, and read and acknowledge any terms and conditions.

Step 3: Review Your Order

In this Step 3, the customer is asked to review their photo, pet name, and shipping/billing information.

Step 4: Check Out

In this Step 4, the customer is charged a fee (optionally including shipping & handling). Customers may also be charged sales tax if required.

### Example 2

### Cosmetics

A specialty cosmetic preparation may be proposed to be designed and manufactured based upon the unique needs and attributes of the consumer. Rather than present it in standard or generic packaging, the preparation is optionally presented in customized packaging based jointly upon the brand identity and the consumer's unique preferences.

In this case, the consumer's preferences are gathered and stored in the database as a consequence of formulating the product. The brand identity is also stored in the database as a template. The basic brand identity is then automatically combined with specific information from the consumer's preferences, which include, but are not limited to, ingredients, instructions, warnings, benefits, etc. Furthermore, specific color effects and symbology that are attractive specifically to this consumer are also integrated into the template.

Once the integration is completed, the digital file is sent for converting where it is output, cut and combined, for example by gluing, into a finished package. Internal packaging and/or documentation based upon the same combination of brand and personal data may also be generated. The packaging is combined with the product and sent to the consumer.

At a specified time, a message (electronic or conventional) is generated and passed to the consumer. This message may also be based upon the same visual and informational attributes as the packaging and the underlying product. The message may be a follow-on offer sent at a time anticipating a reorder (based upon the personalized usage instructions), an offer for a collateral product, or a even a message designed to maintain mindshare.

### Example 3

### Self Portrait

A major national brand may propose to engage its consumers on a more personal level. It optionally develops a promotion that will enable the consumer to place his or her image on a package along with personal information. The brand makes this available through a website, attracting individuals to it via an email campaign as well as information on the standard mass packaging.

The consumer goes to the site and is asked to supply certain information about himself or herself. The consumer may then upload an image via an integrated program or by means of following an email link and including an image. The data and images are combined with the brand template to form a digital file of a package with the consumer's picture and information appearing on the package. The consumer inspects the combined resultant and accepts the proof.

The file is then sent to an appropriate conversion device and the desired can, bag, box, or card is completed. The package is then sent to the consumer. At a specified time, a digital coupon is sent to the consumer on which the consumer's likeness on the package is included. The new personalized identity of the brand can be extended through multiple offers with the consumer.

### Example 4

### Personalized Wedding Favor Tins

A bride and groom want to provide each of their wedding guests with favors as a tangible reminder of their celebration. They choose to purchase customized candies (e.g., M&M's™) with their initials imprinted on each piece. They want to present them to their guests in a tin with their picture, the date of the wedding and their names.

They order the candies and then go to a site offering the tins. They select the shape, size and configuration of the tin. Next they are presented with a template representing the area of the tin that can be customized. Using the provided interface they upload their announcement picture. The picture is now represented on the template. Using integrated controls at the site, they reposition and enlarge the picture so that their faces are more central and prominent. Next they select a font, size and color. They enter the date of the wedding as well as their shared name. They reposition the text in an appropriate area and indicate that they are done.

A graphic representation of the final product is available for their final on-line inspection. They catch a typo, make the change and accept the proof. They select the desired number and place their order.

The combined image, text and tin information is relayed to a production facility where the image and text are digitally transferred to the tins. The tins are then wrapped, packed and shipped out the customers.

### Example 5

### Branded Moving Boxes

A large distributor/manufacturer of moving boxes wants to offer smaller movers the opportunity to make an assortment of moving boxes with their own logo and contact information on each box. They establish a website which allows each mover to view a selection of boxes and choose those that wish to customize.

A mover would make his box selection and be presented on screen with a template representing the outer dimensions of the box. After selecting his box and the quantity required (which is less than a typical production run), he would upload his logo and type in his contact information which would then be represented on the template. He would also have the capability to scale the logo or contact information up or down as well as reposition it and copy it to other panels.

Once satisfied with the box, he would inspect and approve an on-line proof. The resultant file that represents the aggregated logo, textual information, positioning and box specifications is sent to manufacturing for limited production.

### Example 6

### Branded Dry Cleaner Bags

A large distributor/manufacturer of cello dry cleaning bags used to cover cleaned garments on hangers wants to offer companies the opportunity to advertise on the bags in limited quantities for dated specific events such as local store openings, special events and sales. They establish a website which allows each company to create bags with their message and images and they will distribute them to the appropriate dry cleaners based upon demographic and geographic criteria.

The advertising company would be presented on screen with a template representing the dimensions of each side of the bag. After indicating the requested demographic and geographic distribution points, they would select the quantity required (which is less than a typical production run), and then upload any art work and messaging which would then be represented on the template. They would also have the capability to scale the images up or down as well as reposition it and copy it to the back panel. If they want a distinct image on the back they would simply repeat the steps for the reverse.

Once satisfied with the bag, they would inspect and approve an on-line proof. The resultant file that represents the aggregated images, information, positioning and bag specifications is sent to manufacturing for limited production.

Although the invention is illustrated and described herein with reference to specific embodiments and examples, the invention is not intended to be limited to the details shown. Rather, various modifications may be made in the details within the scope and range of equivalents of the claims and without departing from the invention.

What is claimed:

1. A method for personalizing packaging for a product comprising the steps of:
offering personalized packaging for the product to a customer;
receiving text, images, or text and images from the customer;
integrating the text, images, or text and images into personalized packaging;
providing the product with the personalized packaging to the customer; and
providing promotional information for the product or another product to the customer.

2. The method of claim 1, further comprising the steps of:
generating supplemental promotional information based on a new product using the text, images, or text and images; and
providing the supplemental promotional information for the new product to the customer.

3. The method of claim 1, wherein the step of integrating the text, images, or text and images into personalized packaging includes the steps of:
combining the text, images, or text and images with common elements associated with the product; and
producing a limited run of the personalized packaging with the text, images, or text and images combined with the common elements.

4. The method of claim 3, wherein the limited run is equal to one of the personalized packaging.

5. The method of claim 3, wherein a digital printing press is utilized in the producing step to produce the personalized packaging.

6. A system for personalizing packaging for a product comprising:
means for offering personalized packaging for the product to a customer;
means for receiving text, images, or text and images from the customer;
means for integrating the text, images, or text and images into personalized packaging;
means for associating the product with the personalized packaging; and
means for preparing promotional information for the product or another product.

7. The system of claim 6, wherein the means for integrating the text, images, or text and images into personalized packaging includes a combination unit and a production unit.

8. The system of claim 7, wherein the combination unit includes a computer processing unit configured to combine the text, images, or text and images with common elements associated with the product.

9. The system of claim 8, wherein the computer processing unit also functions as the means for receiving text, images, or text and images from the customer.

10. The system of claim 7, wherein the production unit includes a digital printing press.

11. The system of claim 7, wherein the promotional information for the product or another product includes at least a portion of the text, images, or text and images received from the customer.

12. A system for personalizing packaging for a product comprising:
a receiving unit configured to receive customer information and a brand selection from a customer;
a combination unit configured to combine the customer information and the brand selection; and
a scalable production unit configured to produce a personalized package including the customer information and the brand selection.

13. The system of claim 12, wherein the combination unit includes a computer processing unit configured to combine the customer information and the brand selection.

14. The system of claim 13, wherein the computer processing unit also functions as the receiving unit.

15. The system of claim 12, wherein the scalable production unit includes a digital printing press.

16. A method for personalizing packaging for a product comprising the steps of:
obtaining rights to packaging formats for products;
offering personalized packaging for the products to a customer;
receiving a selection from the customer including a product, a packaging format corresponding to the selected product, and personal information corresponding to the selected packaging format;
integrating the personal information into personalized packaging; and
providing the selected product with the personalized packaging to the customer.

17. A method for personalizing packaging for a product comprising the steps of:
combining custom information provided by a customer with standard elements to form a customized packaging design;
preparing a limited run of customized packaging having the customized packaging design;
providing the customized packaging to the customer; and
providing follow-on marketing to the customer using components of the customized packaging design.

18. A system for personalizing packaging for a product comprising:
an interface configured to receive custom information from a customer;
a computer configured to combine the custom information with standard elements to form a customized packaging design;
a printer configured to prepare a limited run of customized packaging having the customized packaging design; and
a communication device configured to deliver follow-on marketing to the customer including components of the customized packaging design.

19. A method for personalizing packaging including the steps of:
identifying personalized information that a customer wishes to be incorporated into personalized packaging;
offering a selection of available templates including a brand;
combining the personalized information with a selected template to produce personalized packaging;
delivering the personalized packaging to the customer; and
incorporating the personalized information into follow-on promotional materials associated with the brand.

20. The method of claim 1 wherein the step of offering personalized packaging includes offering boxes, bags, tubes, pouches, cans, tins or wraps or combinations thereof.

21. The method of claim 2, wherein the step of generating supplemental promotional information comprises generating digital or physical information.

22. The method of claim 3, wherein the step of producing a limited run comprises producing greater than or equal to one and less than a conventional mass production run.

23. The system of claim 6 further comprising:
means for optional positioning, orienting or modifying the text, images, or text and images resulting in changed text, images, or text and images;
means for proofing the original text, images, or text and images or the changed text, images, or text and images; and
means for on-line proofing and acceptance of an image of the personalized packaging.

24. The system of claim 6, wherein said means for preparing promotional information for the product or another product uses the changed or original text, images, or text and images or an image of the personalized packaging.

25. The method of claim 16 further comprising the steps of:
altering the information; and
on-line proofing of the information.

26. The method of claim 19 further comprising the step of proofing the personalized packaging.
